(19) United States
(12) Patent Application Publication
(10) Pub. No.: US 2025/0347543 A1
(43) Pub. Date: Nov. 13, 2025

(54) MIXED-PHASE FLUID MASS FLOW MEASUREMENT METHOD AND THROTTLING-TYPE PHOTON QUANTUM MIXED-PHASE FLOWMETER

(71) Applicants: Chengdu Sea Pioneers Technology Co., Ltd., Chengdu (CN); Wuxi Sea Pioneers Technology Co., Ltd., Wuxi, Jiangsu (CN)

(72) Inventors: Jige Chen, Chengdu (CN); Bin Xu, Chengdu (CN); Meng Fu, Chengdu (CN); Chao Luo, Chengdu (CN); Shan Sun, Chengdu (CN); Haibo Liang, Chengdu (CN)

(21) Appl. No.: 19/201,949

(22) Filed: May 8, 2025

(30) Foreign Application Priority Data
May 8, 2024 (CN) 202410565241.4

(51) Int. Cl. G01F 1/34; G01F 1/661; G01F 15/10

(52) U.S. Cl. CPC G01F 1/34; G01F 1/661; G01F 15/10

(57) ABSTRACT

The present disclosure provides a mixed-phase fluid mass flow measurement method and a throttling-type photon quantum mixed-phase flowmeter, after real-time acquisition of the actual pressure value, actual temperature value, and the actual photon quantum transmission quantity under the influence of the to-be-measured mixed-phase fluid for at least three photon quantum energy levels at the inlet pipe section of the throttling-type photon quantum mixed-phase flowmeter, and after the acquisition of the actual pressure difference between the inlet pipe section and the throat pipe section, the present disclosure will directly calculate the actual mass flow rate of the fluid media of each phase in the to-be-measured mixed-phase fluid based on the actual photon quantum transmission quantities for the at least three photon quantum energy levels, the photon quantum transmission quantity without medium, and the obtained actual pressure value, actual temperature value, and actual pressure difference.

### CROSS-REFERENCES TO RELATED APPLICATIONS

The present disclosure claims priority to Chinese Patent Application No. 2024105652414, entitled “MIXED-PHASE FLUID MASS FLOW MEASUREMENT METHOD AND THROTTLING-TYPE PHOTON QUANTUM MIXED-PHASE FLOWMETER” filed on May 8, 2024 with the Chinese Patent Office, the entire contents of which are incorporated herein by reference.

### TECHNICAL FIELD

The present disclosure relates to the technical field of industrial mixed-phase fluid measurement, and more particularly, to a mixed-phase fluid mass flow rate measurement method and a throttling-type photon quantum mixed-phase flowmeter.

### BACKGROUND ART

Petroleum is a fluid mineral deeply buried underground, which generally comprises a complex mixture consisting of gaseous hydrocarbon compounds (for example, natural gas), liquid hydrocarbon compounds (for example, oily liquid minerals), solid hydrocarbon compounds (for example, asphalt), and a small number of impurities (for example, water) existing in nature. In an early stage of petroleum extraction, due to complicated and unstable distribution condition and variation condition of four-phase substances of oil, gas, water, and solids in a reservoir, it is generally required to perform real-time monitoring on dynamic change of oil, gas, water, solid and other components in a mixed-phase fluid output from an oil-gas well, so as to facilitate improvement in separation accuracy during subsequent oil-gas-solid phase separation process performed on the mixed-phase fluid.

However, it is noteworthy that various types of mixed-phase flowmeters adopted as current mainstream in the industry are generally applicable to respectively perform real-time mass flow rate measurement on multiphase fluid medium (for example, three-phase substances including oil, gas, water) in high-flow-rate mixed-phase fluid at a high-yield oil-gas well, but are essentially incapable of achieving high-precision real-time mass flow rate measurement on low-flow-rate mixed-phase fluid at a low-yield oil-gas well.

### SUMMARY

In view of this, the objective of the present disclosure is to provide a mixed-phase fluid mass flow rate measurement method and a throttling-type photon quantum mixed-phase flowmeter, which can perform multi-energy-level photon quantum measurement at an inlet pipe section of the throttling-type photon quantum mixed-phase flowmeter, and can directly calculate actual mass flow rate of each phase fluid medium in the to-be-measured mixed-phase fluid based on a photoelectric effect principle, a Compton effect principle, a mass conservation principle, and a fluid continuity principle, so as to ensure applicability of the corresponding throttling-type photon quantum mixed-phase flowmeter to high-precision real-time mass flow rate measurement on low-flow-rate mixed-phase fluid at a low-yield oil-gas well.

In order to achieve the objective above, the embodiments of the present disclosure apply the following technical solutions.

In a first aspect, the present disclosure provides a mixed-phase fluid mass flow measurement method, applied to a throttling-type photon quantum mixed-phase flowmeter, wherein the throttling-type photon quantum mixed-phase flowmeter includes a hollow tube body, a multi-level photon quantum source, and a photon quantum probe, wherein an inlet pipe section of the hollow tube body is in communication with a throat pipe section via a contraction pipe section, and is configured to transport a to-be-measured mixed-phase fluid to the throat pipe section; the multi-level photon quantum source is arranged within the inlet pipe section and is configured to emit photon quantum of at least three energy levels according to a preset photon quantum emission rate; the photon quantum probe is arranged opposite to the multi-level photon quantum source and is configured to detect a photon quantum transmission quantity for each of the at least three energy levels; and the mixed-phase fluid mass flow measurement method includes:
acquiring an actual photon quantum transmission quantity for each of the at least three energy levels under an influence of the to-be-measured mixed-phase fluid in real-time, an actual pressure value and an actual temperature value at the inlet pipe section, and an actual pressure difference between the inlet pipe section and the throat pipe section;
constructing a target Compton absorption equation and at least two photoelectric absorption equations for the to-be-measured mixed-phase fluid based on the actual photon quantum transmission quantity for each of the at least three energy levels and a pre-stored photon quantum transmission quantity without medium of each of the at least three energy levels in the inlet pipe section, where each absorption equation corresponds to one energy level;
according to the actual pressure value, the actual temperature value, and the actual pressure difference, calculating a total fluid mass flow rate and a gas phase mass flow rate of the to-be-measured mixed-phase fluid based on the target Compton absorption equation, wherein the gas phase mass flow rate is an actual mass flow rate of a gas phase fluid medium in the to-be-measured mixed-phase fluid; and
jointly solving the at least two photoelectric absorption equations and the target Compton absorption equation based on the calculated total fluid mass flow rate and gas phase mass flow rate, to obtain the actual mass flow rate of each phase fluid medium in the to-be-measured mixed-phase fluid.

In optional embodiments, a first energy level with a greatest energy value among the at least three energy levels corresponds to the target Compton absorption equation, and each second energy level among all energy levels other than the first energy level in the at least three energy levels corresponds to one photoelectric absorption equation respectively; and at this time, the step of constructing a target Compton absorption equation and at least two photoelectric absorption equations for the to-be-measured mixed-phase fluid based on the actual photon quantum transmission quantity for each of the at least three energy levels and a pre-stored photon quantum transmission quantity without medium of each of the at least three energy levels in the inlet pipe section includes:
acquiring a discharge coefficient of the throttling-type photon quantum mixed-phase flowmeter, a photon quantum absorption coefficient of each phase fluid medium in the to-be-measured mixed-phase fluid for each second energy level respectively, and a Compton scattering coefficient of the throttling-type photon quantum mixed-phase flowmeter for the first energy level;
constructing, for each second energy level, a photoelectric absorption equation matching the second energy level based on a photoelectric effect principle based on the actual photon quantum transmission quantity and the photon quantum transmission quantity without medium that are corresponded with the second energy level, and the photon quantum absorption coefficient of each phase fluid medium for the second energy level; and
according to the actual photon quantum transmission quantity, the photon quantum transmission quantity without medium, and the Compton scattering coefficient, three of which are corresponded with the first energy level, and according to the discharge coefficient of the throttling-type photon quantum mixed-phase flowmeter, constructing, for the first energy level, the target Compton absorption equation with respect to each phase fluid medium matching the first energy level based on a Compton effect principle, a mass conservation principle, and a fluid continuity principle.

In optional embodiments, the photoelectric absorption equation matching a i-th of second energy level is expressed by the following formula:

$$ln ( \frac{{N}_{0 , i}}{{N}_{X , i}} ) = {\sum }_{j = 1}^{n} {α}_{j , i} {Q}_{j} ,$$

where N_{0,i} is used to represent the actual photon quantum transmission quantity corresponding to the i-th type of second energy level, N_{X,i} is used to represent the photon quantum transmission quantity without medium corresponding to the i-th type of second energy level, α_{j,i} is used to represent the photon quantum absorption coefficient of a j-th phase fluid medium in the to-be-measured mixed-phase fluid for the i-th type of second energy level, Qⱼ is used to represent the actual mass flow rate of the j-th phase fluid medium in the to-be-measured mixed-phase fluid, and n is used to represent a total number of fluid medium phases in the to-be-measured mixed-phase fluid.

In optional embodiments, the target Compton absorption equation matching the first energy level is expressed by the following formula:

$$\{ \begin{matrix}{Q}_{t} = {\sum }_{j = 1}^{n} {Q}_{j} = C * {ρ}_{mix 2} * \sqrt{\frac{2 Δ P}{{ρ}_{mix 2} - {ρ}_{mix 1} * {( \frac{S 2}{S 1} )}^{2}}} \\ ln ( \frac{{N}_{0 , A}}{{N}_{X , A}} ) = M * {ρ}_{mix 1}\end{matrix} ,$$

where N_{0,A} is used to represent the actual photon quantum transmission quantity corresponding to the first energy level, N_{X,A} is used to represent a photon quantum transmission quantity without medium corresponding to the first energy level, Qₜ is used to represent a total fluid mass flow rate of the to-be-measured mixed-phase fluid, M is used to represent a Compton scattering coefficient corresponding to the first energy level, C is used to represent a discharge coefficient of the throttling-type photon quantum mixed-phase flowmeter, ΔP is used to represent an actual pressure difference between the inlet pipe section and the throat pipe section, ρₘᵢₓ₁ is used to represent an average mixed density of the to-be-measured mixed-phase fluid at a pipe cross-section of the inlet pipe section, ρmᵢₓ₂ is used to represent an average mixed density of the to-be-measured mixed-phase fluid at a pipe cross-section of the throat pipe section, S1 is used to represent a pipe cross-sectional area of the inlet pipe section, and S2 is used to represent a pipe cross-sectional area of the throat pipe section.

In optional embodiments, the step of according to the actual pressure value, the actual temperature value, and the actual pressure difference, calculating a total fluid mass flow rate and a gas phase mass flow rate of the to-be-measured mixed-phase fluid based on the target Compton absorption equation includes:
according to the actual pressure value and the actual temperature value, calculating a first gas density of the gas phase fluid medium at the inlet pipe section based on a perfect gas state equation;
according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section;
according to the actual pressure value, the actual temperature value, and the actual pressure difference, calculating a second gas density of the gas phase fluid medium at the throat pipe section;
acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section;
substituting the first average mixed density, the second average mixed density, and the actual pressure difference into the target Compton absorption equation for calculation, so as to obtain the total fluid mass flow rate of the to-be-measured mixed-phase fluid; and
according to the second average mixed density, the target volume gas content, the second gas density, and the total fluid mass flow rate, calculating the gas phase mass flow rate based on a gas mass conservation principle.

In optional embodiments, the step of according to the actual pressure value, the actual temperature value, and the actual pressure difference, calculating a second gas density of the gas phase fluid medium at the throat pipe section includes:
calculating an expected pressure value at the throat pipe section based on the actual pressure value and the actual pressure difference;
calculating an expected temperature value of the gas phase fluid medium at the throat pipe section based on the actual pressure value, the expected pressure value, and the actual temperature value, and based on a principle of reversible adiabatic process; and
calculating the second gas density of the gas phase fluid medium at the throat pipe section based on the expected pressure value and the actual temperature value, and based on the perfect gas state equation.

In optional embodiments, the step of calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section includes:
calculating an actual volume gas content of the to-be-measured mixed-phase fluid at the inlet pipe section based on the first average mixed density, the actual density value, and the first gas density;
calculating the target volume gas content based on the actual volume gas content, the pipe cross-sectional areas of the inlet pipe section and the throat pipe section, and based on a fixed property of a non-gas-phase fluid medium density; and
performing a mixed density calculation based on the second gas density, the actual density value, and the target volume gas content to obtain the second average mixed density.

In optional embodiments, the mixed-phase fluid mass flow measurement method further includes:
performing, for each phase fluid medium in the to-be-measured mixed-phase fluid, a ratio calculation between the actual mass flow rate of the corresponding phase fluid medium and the total fluid mass flow rate to obtain a mass phase fraction of the phase fluid medium in the to-be-measured mixed-phase fluid.

In a second aspect, the present disclosure provides a throttling-type photon quantum mixed-phase flowmeter, wherein the throttling-type photon quantum mixed-phase flowmeter includes a hollow pipe body, a multi-level photon quantum source, a photon quantum probe, a multi-parameter sensor, and a main control unit;
an inlet pipe section of the hollow pipe body is in communication with a throat pipe section via a contraction pipe section, and is configured to transport a to-be-measured mixed-phase fluid, which is injected into the inlet pipe section, to the throat pipe section;
the multi-level photon quantum source is arranged in the inlet pipe section and is configured to emit photon quantum of at least three energy levels according to a preset photon quantum emission rate;
the photon quantum probe is mounted on the hollow pipe body and is arranged opposite to the multi-level photon quantum source within the inlet pipe section, and is configured to detect the photon quantum transmission quantity of each of the at least three energy levels;
the multi-parameter sensor is mounted on the hollow pipe body and is configured to monitor in real-time the actual pressure value and actual temperature value at the inlet pipe section, and the actual pressure difference between the inlet pipe section and the throat pipe section; and
the main control unit is communicatively connected with the multi-level photon quantum source, the multi-parameter sensor, and the photon quantum probe simultaneously, and is configured to control a working state of the multi-level photon quantum source, the multi-parameter sensor, and the photon quantum probe, wherein the main control unit further stores a computer program and can execute the computer program to implement the mixed-phase fluid mass flow measurement method according to any one of the embodiments above.

In optional embodiments, the inlet pipe section includes a large-diameter straight pipe section, a diameter-reducing pipe section, and a waist-shaped straight pipe section, wherein the large-diameter straight pipe section is in communication with the waist-shaped straight pipe section via the diameter-reducing pipe section, and the large-diameter straight pipe section is configured to inject the to-be-measured mixed-phase fluid; and
the waist-shaped straight pipe section includes two planar walls that are parallel and arranged at intervals, the multi-level photon quantum source is arranged on one planar wall, and the photon quantum probe is arranged on the other planar wall, wherein the multi-level photon quantum source is an exempt-level Ba-133 photon quantum source.

In this case, the beneficial effects of the embodiments of the present disclosure can include the following contents.

The method includes acquiring, in real-time, an actual pressure value, an actual temperature value, and an actual photon quantum transmission quantity of at least three photon quantum energy levels under the influence of the to-be-measured mixed-phase fluid at an inlet pipe section of the throttling-type photon quantum mixed-phase flowmeter, and actual pressure difference value between the inlet pipe section and the throat pipe section; then, based on the obtained actual photon quantum transmission quantity and photon quantum transmission quantity without medium of each of at least three photon quantum energy levels in the inlet pipe section, constructing a target Compton absorption equation and at least two photoelectric absorption equations for the to-be-measured mixed-phase fluid; next, according to the obtained actual pressure value, the actual temperature value, and the actual pressure difference, calculating a total fluid mass flow rate and a gas phase mass flow rate of the to-be-measured mixed-phase fluid based on the target Compton absorption equation; and finally, based on the calculated total fluid mass flow rate and gas phase mass flow rate, jointly solving all constructed absorption equations to obtain actual mass flow rate of each phase fluid medium in the to-be-measured mixed-phase fluid. Therefore, multi-energy-level photon quantum measurement can be performed at an inlet pipe section of the throttling-type photon quantum mixed-phase flowmeter. The method of directly calculating actual mass flow rate of each phase fluid medium in the to-be-measured mixed-phase fluid based on a photoelectric effect principle, a Compton effect principle, a mass conservation principle, and a fluid continuity principle, ensures applicability of the throttling-type photon quantum mixed-phase flowmeter to high-precision real-time mass flow rate measurement on low-flow-rate mixed-phase fluid at a low-yield oil-gas well.

To make the above objectives, features, and advantages of the present disclosure more evident and comprehensible, the following preferred embodiments are described in detail with the drawings.

### BRIEF DESCRIPTION OF DRAWINGS

To more clearly illustrate the technical solutions of the embodiments of the present disclosure, the following will briefly introduce the drawings used in the embodiments. It should be understood that the following drawings only show some embodiments of the present disclosure, and therefore they should not be regarded as a limitation on the scope. Those ordinary skilled in the art can also obtain other related drawings based on these drawings without inventive effort.

FIG. 1 is a structural schematic diagram of a throttling-type photon quantum mixed-phase flowmeter provided in the embodiment of the present disclosure in a first view;

FIG. 2 is a structural schematic diagram of a throttling-type photon quantum mixed-phase flowmeter provided in the embodiment of the present disclosure in a second view;

FIG. 3 is a sectional schematic diagram of section A-A in FIG. 2;

FIG. 4 is a sectional schematic diagram of section B-B in FIG. 2;

FIG. 5 is a flow schematic diagram of a mixed-phase fluid mass flow rate measurement method provided in the embodiment of the present disclosure;

FIG. 6 is a flow schematic diagram of sub-steps included in step 220 in FIG. 5;

FIG. 7 is a flow schematic diagram of sub-steps included in step 230 in FIG. 5; and

FIG. 8 is another flow schematic diagram of a mixed-phase fluid mass flow rate measurement method provided in the embodiment of the present disclosure.

Reference numerals: 10—throttling-type photon quantum mixed-phase flowmeter; 11—main control unit; 12—hollow tube body; 13—multi-energy-level photon quantum source; 14—photon quantum probe; 15—multi-parameter sensor; 121—inlet pipe section; 122—contraction pipe section; 123—throat pipe section; 124—outlet pipe section; 125—large-diameter straight pipe section; 126—diameter-reducing pipe section; 127—waist-shaped straight pipe section.

### DETAILED DESCRIPTION OF EMBODIMENTS

In order to make the objective, technical solution, and advantages of the present disclosure clearer, the following will provide a clear and complete description of the technical solution in the embodiments of the present disclosure, in conjunction with the drawings in the embodiments of the present disclosure. Obviously, the described embodiments are a part of the embodiments of the present disclosure, rather than all embodiments. The components of embodiments of the present disclosure which are generally described and illustrated in the drawings herein can be arranged and designed in a variety of different configurations.

Accordingly, the following detailed description of the embodiments of the present disclosure provided in the drawings is not intended to limit the scope of the claimed disclosure, but merely represents selected embodiments of the present disclosure. Based on the embodiments of the present disclosure, all other embodiments obtained by those of ordinary skill in the art without making inventive efforts are within the scope of protection of the present disclosure.

It should be noted that similar numerals and letters denote similar terms in the following drawings so that once an item is defined in one drawing, it does not need to be further discussed in subsequent drawings.

In the description of the present disclosure, it is to be understood that the terms such as “center”, “upper”, “lower”, “left”, “right”, “vertical”, “horizontal”, “inner”, “outer”, and the like indicate orientation or positional relationships based on the orientation or positional relationships shown in the drawings, or the orientation or positional relationships that are customarily placed during use of the product of the present disclosure, or the orientation or positional relationships that are customarily understood by those skilled in the art. They are merely for convenience of describing the present disclosure and simplifying the description, and are not intended to indicate or imply that the devices or elements referred to must have specific orientation, be constructed in specific orientation, and operate in specific orientation, and therefore shall not be construed as a limitation to the present disclosure.

In the description of the present disclosure, it should also be noted that unless otherwise clearly stipulated and limited, the terms “provide”, “mount”, “interconnect”, and “connect” should be understood in a broad sense, for example, it can be a fixed connection, a detachable connection, or an integral connection; it can be a mechanical connection or an electrical connection; and it can be a direct connection, an indirect connection through an intermediary, or an internal communication between two components. Those of ordinary skill in the art can understand the meanings of the above terms in the present disclosure according to specific situations.

In addition, in the description of the present disclosure, it can also be understood that, the terms “first”, “second”, and other similar relational terms are used merely to distinguish one entity or operation from another, and do not necessarily require or imply any actual relationship or sequence between these entities or operations. Furthermore, the terms “comprise”, “include”, or any other variations are intended to encompass non-exclusive inclusion. This allows a process, method, item, or device that includes a series of elements to not only include those elements but also include other elements that are not explicitly listed, or elements that are inherent to the process, method, item, or device. In the absence of further limitations, the inclusion of an element specified by the phrase “comprising a . . . ” does not exclude the presence of additional identical elements in the process, method, article, or apparatus that includes the specified element. Those of ordinary skill in the art can understand the meanings of the above terms in the present disclosure according to specific situations.

Although various mixed-phase flowmeters currently used in the industry mainly use the photon quantum measurement technology to perform mass flow rate measurement on multiple fluid medium in the mixed-phase fluid, the existing mixed-phase flowmeters are basically constructed and formed based on conventional Venturi tubes, and usually require performing photon quantum measurement at the throat pipe section with the smallest pipe size of the conventional Venturi tube for high-flow-rate mixed-phase fluid. This ensures that the mass flow of multiple fluid medium in the high-flow-rate mixed-phase can be measured with sufficiently high accuracy. However, as the actual flow rate of the injected mixed-phase fluid into the mixed-phase flowmeter is significantly reduced, the currently produced mixed-phase flowmeters are substantially unable to be adapted to low-flow-rate mixed-phase fluid. Even if the throat pipe section size of the mixed-phase flowmeter is reduced synchronously, due to factors such as manufacturing process limitations and material physical property limitations of the pipe, the corresponding throat pipe section size has a lower limit of size reduction. This results in the adjusted mixed-phase flowmeter still being substantially unable to be adapted to low-flow-rate mixed-phase fluid.

In this case, in order to solve the above problems, the present disclosure provides a mixed-phase fluid mass flow rate measurement method and a throttling-type photon quantum mixed-phase flowmeter, which can perform multi-energy-level photon quantum measurement at an inlet pipe section of the throttling-type photon quantum mixed-phase flowmeter, and can directly calculate actual mass flow rate of each phase fluid medium in the to-be-measured mixed-phase fluid based on a photoelectric effect principle, a Compton effect principle, a mass conservation principle, and a fluid continuity principle, so as to ensure applicability of the throttling-type photon quantum mixed-phase flowmeter to high-precision real-time mass flow rate measurement effect on low-flow-rate mixed-phase fluid at a low-yield oil-gas well. This effectively avoids the limitation on mass flow rate measurement capability brought to the existing mixed-phase flowmeter by the throat pipe section size.

Some embodiments of the present disclosure are described in detail below, in conjunction with the drawings. The following embodiments and features in the embodiments can be in conjunction with each other in a non-conflicting manner.

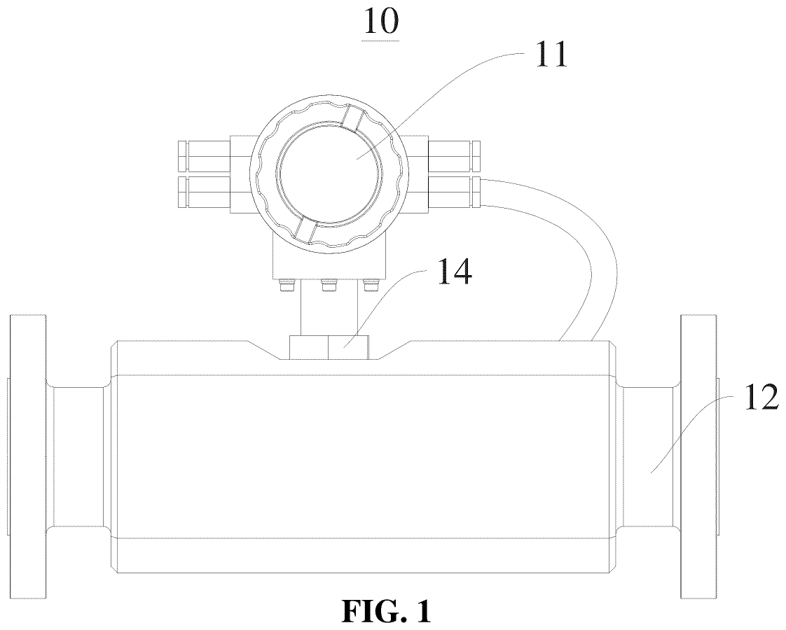

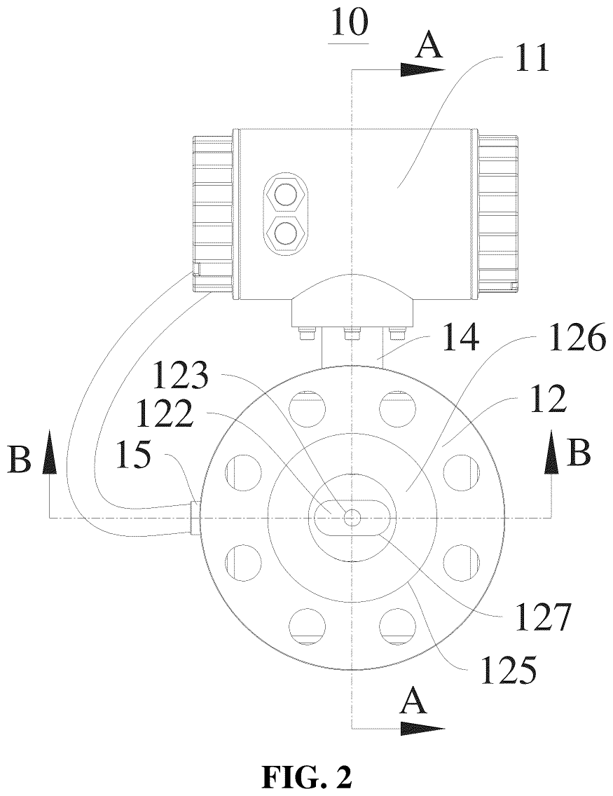

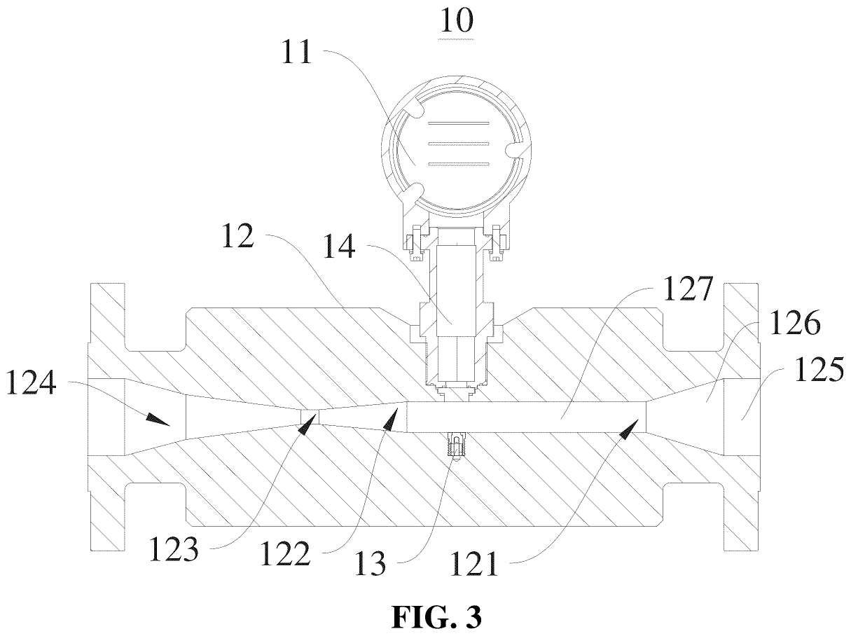

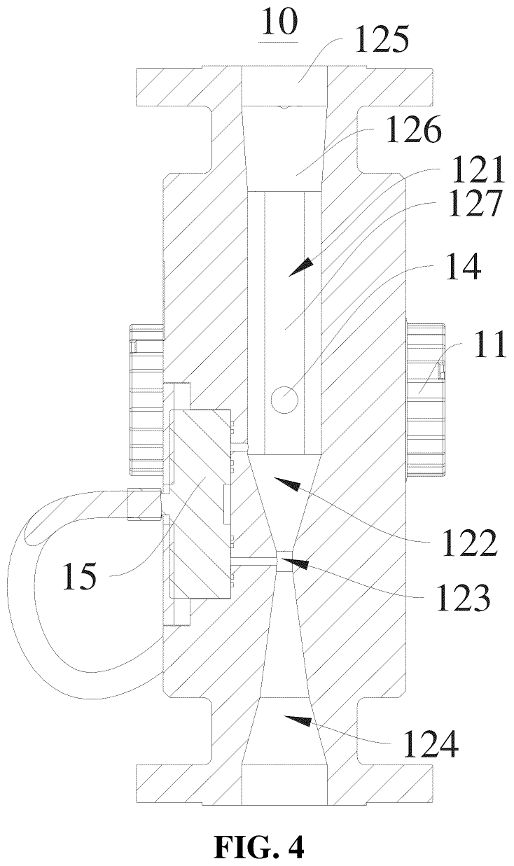

With reference to FIG. 1, FIG. 2, FIG. 3 and FIG. 4, FIG. 1 is a structural schematic diagram of a throttling-type photon quantum mixed-phase flowmeter 10 provided in the embodiment of the present disclosure in a first view; FIG. 2 is a structural schematic diagram of a throttling-type photon quantum mixed-phase flowmeter 10 provided in the embodiment of the present disclosure in a second view; FIG. 3 is a sectional schematic diagram of section A-A in FIG. 2; and FIG. 4 is a sectional schematic diagram of section B-B in FIG. 2. In an embodiment of the present disclosure, the throttling-type photon quantum mixed-phase flowmeter 10 can include a hollow pipe body 12, a multi-level photon quantum source 13, a photon quantum probe 14, a multi-parameter sensor 15, and a main control unit 11.

In the embodiment, the hollow tube body 12 includes an inlet pipe section 121, a contraction pipe section 122, a throat pipe section 123, and an outlet pipe section 124, wherein the inlet pipe section 121 communicates with the throat pipe section 123 through the contraction pipe section 122, the throat pipe section 123 communicates with the outlet pipe section 124, a pipe port size of the contraction pipe section 122 close to the inlet pipe section 121 is greater than a pipe port size close to the throat pipe section 123, and a pipe port size of the outlet pipe section 124 close to the throat pipe section 123 is smaller than a pipe port size away from the throat pipe section 123. One end of the inlet pipe section 121 away from the contraction pipe section 122 is provided with a first flange, to connect an oil-and-gas collection pipeline of a single oil-gas well through the first flange. At the same time, one end of the outlet pipe section 124 away from the throat pipe section 123 is provided with a second flange, to connect an oil-and-gas transmission pipeline of the oil-gas well through the second flange. Therefore, a to-be-detected mixed-phase fluid collected by the oil-gas well can flow out from the outlet pipe section 124 after entering the inlet pipe section 121 through the contraction pipe section 122 and the throat pipe section 123, wherein the to-be-detected mixed-phase fluid at least includes a gas phase fluid medium.

In the embodiment, the multi-level photon quantum source 13 is arranged in the inlet pipe section 121, and a photon quantum emission direction of the multi-level photon quantum source 13 is perpendicular to a central axis of the tube body of the inlet pipe section 121, which is configured to emit photon quantum of at least three energy levels at a preset photon quantum emission rate. The at least three energy levels include a first energy level satisfying a Compton effect and at least two second energy levels satisfying a photoelectric effect, wherein an energy value corresponding to the first energy level is greater than an energy value corresponding to any one of the second energy levels, namely an energy value of the first energy level is maximum among the at least three energy levels. The multi-level photon quantum source 13 maintains consistency with the actual photon quantum emission rate respectively corresponding to the at least three energy levels, and is the preset photon quantum emission rate (for example, emitting one million photon quantum per second). The multi-level photon quantum source 13 can be a Ba-133 photon quantum source. The second energy levels involved in the multi-level photon quantum source 13 can include at least two energy levels among 31 keV energy level, 53 keV energy level, 81 keV energy level, and 160 keV energy level. The first energy level involved in the multi-level photon quantum source 13 can be any one of the 276 keV energy level, 302 keV energy level, 356 keV energy level, and 383 keV energy level. In one embodiment of the present embodiment, the first energy level involved in the multi-level photon quantum source 13 is 356 keV energy level, and two second energy levels involved in the multi-level photon quantum source 13 are respectively 31 keV energy level and 81 keV energy level.

In the present embodiment, the photon quantum probe 14 is mounted on the hollow pipe body 12 and is arranged opposite to the multi-level photon quantum source 13 within the inlet pipe section 121, which is configured to detect the photon quantum transmission quantity respectively corresponding to the at least three energy levels. The photon quantum probe 14 can effectively detect the actual photon quantum transmission quantity of each of the at least three energy levels under the interference influence of the to-be-detected mixed-phase fluid when the to-be-detected mixed-phase fluid exists in the inlet pipe section 121. The photon quantum probe 14 can also directly detect the photon quantum transmission quantity without medium of each of the at least three energy levels in the inlet pipe section 121 when no fluid medium (for example, gaseous hydrocarbon compound, liquid hydrocarbon compound, water, and solid hydrocarbon compound) exists in the inlet pipe section 121.

In the present embodiment, the multi-parameter sensor 15 is mounted on the hollow pipe body 12 and is configured to monitor in real-time the actual pressure value and actual temperature value at the inlet pipe section 121, and the actual pressure difference between the inlet pipe section 121 and the throat pipe section 123. The multi-parameter sensor 15 can include a pressure transmitter, a differential pressure transmitter, and a temperature transmitter. The differential pressure transmitter is configured to detect an actual pressure difference between the inlet pipe section 121 and the throat pipe section 123. For a mixture containing a gas phase substance, the gas phase substance belongs to a volume-compressible substance in the mixture, and a non-gas phase substance in the mixture belongs to a volume-incompressible substance, wherein a density of the gas phase substance will change with pressure and/or temperature, and a density of the non-gas phase substance will remain fixed and unchanged. Therefore, when a to-be-detected mixed-phase fluid in which a gas phase fluid medium exists enters the hollow tube body 12, due to a longer pipe transmission process of the inlet pipe section 121 and sufficient heat exchange, the gas phase fluid medium and the non-gas phase fluid medium (including any one or more combinations of a water phase fluid medium, an oil phase fluid medium, and a solid phase fluid medium) in the to-be-detected mixed-phase fluid can be directly regarded as having a same temperature. Meanwhile, the gas phase fluid medium and the non-gas phase fluid medium are under a consistent pressure in the inlet pipe section 121. However, when the to-be-detected mixed-phase fluid reaches the throat pipe section 123 through the contraction pipe section 122, the to-be-detected mixed-phase fluid will exhibit a phenomenon of “different temperatures/pressures of the gas phase fluid medium and the non-gas phase fluid medium at the same position” under influence of a throttling effect. This makes it impossible to directly measure an actual temperature of the gas phase fluid medium at the throat pipe section 123, and also impossible to directly measure an actual pressure of the gas phase fluid medium at the throat pipe section 123. Therefore, the pressure transmitter is essentially configured to real-time monitor an actual pressure value at the inlet pipe section 121, and the temperature transmitter is essentially configured to real-time monitor an actual temperature value at the inlet pipe section 121.

In the embodiment, the main control unit 11 is in communication connection with the multi-energy-level photon quantum source 13, the multi-parameter sensor 15, and the photon quantum probe 14 simultaneously, and is configured to control respective working states of the multi-energy-level photon quantum source 13, the multi-parameter sensor 15, and the photon quantum probe 14. This makes it easier for the main control unit 11 to control the multi-energy-level photon quantum source 13 and the photon quantum probe 14 to cooperate with each other to perform multi-energy-level photon quantum measurement at the inlet pipe section 121 on the to-be-detected mixed-phase fluid when the to-be-detected mixed-phase fluid is introduced into the hollow tube body 12, and to control the multi-parameter sensor 15 to real-time detect an actual pressure value and an actual temperature value exhibited by the to-be-detected mixed-phase fluid at the inlet pipe section 121 and an actual pressure difference value of the to-be-detected mixed-phase fluid between the inlet pipe section 121 and the throat pipe section 123. Then, based on a photoelectric effect principle, a Compton effect principle, a mass conservation principle that “a volume of a gas phase fluid medium changes but a mass remains unchanged before and after the influence of throttling effect, and both a volume and a mass of a non-gas phase fluid medium remain unchanged”, and a fluid continuity principle that “a mass flow rate of any mixed-phase fluid remains consistent before and after the influence of throttling effect”, the actual mass flow rate of each phase fluid medium in the to-be-detected mixed-phase fluid can be directly calculated. This ensures that the corresponding throttling-type photon quantum mixed-phase flow meter 10 can be applicable to achieving high-accuracy real-time measurement effect of mass flow rate for low-flow-rate mixed-phase fluid at a low-yield oil-gas well, so as to effectively avoid a limitation on mass flow rate measurement capability brought by a throat pipe section size to the mixed-phase flow meter.

The main control unit 11 can pre-store photon quantum transmission quantities without medium of each of the at least three energy levels involved in the multi-energy-level photon quantum source 13 in the inlet pipe section 121. The main control unit 11 further stores a computer program, and can drive the multi-energy-level photon quantum source 13, the multi-parameter sensor 15, and the photon quantum probe 14 to cooperatively operate to perform high-accuracy real-time measurement of mass flow rate for each phase fluid medium in the to-be-detected mixed-phase fluid by running the computer program.

Optionally, in one implementation of the embodiment, the inlet pipe section 121 can include a large-diameter straight pipe section 125, a diameter-reducing pipe section 126, and a waist-shaped straight pipe section 127, wherein the large-diameter straight pipe section 125 is in communication with the waist-shaped straight pipe section 127 via the diameter-reducing pipe section 126, and the large-diameter straight pipe section 125 is configured to inject the to-be-measured mixed-phase fluid. A pipe port size of the diameter-reducing pipe section 126 close to the large-diameter straight pipe section 125 is greater than a pipe port size close to the waist-shaped straight pipe section 127. The waist-shaped straight pipe section 127 includes two planar walls that are parallel and arranged at intervals, wherein the multi-level photon quantum source 13 is arranged on one planar wall, and the photon quantum probe 14 is arranged on the other planar wall. Thus, an actual detection distance between the photon quantum probe 14 and the multi-energy-level photon quantum source 13 is significantly shortened through a waist-shaped hole-like pipe cross-section of the waist-shaped straight pipe section 127, thereby solving a problem of distance limitation when photon quantum emitted by the multi-energy-level photon quantum source 13 penetrates the multiphase fluid medium. Moreover, this further improves mass flow rate measurement accuracy of the throttling-type photon quantum mixed-phase flow meter 10, and at this time, the multi-energy-level photon quantum source 13 can also directly adopt an exemption-level Ba-133 photon quantum source for realization.

In the present disclosure, in order to ensure that the above throttling-type photon quantum mixed-phase flow meter 10 can effectively achieve high-accuracy mass flow rate real-time measurement effect for low-flow-rate mixed-phase fluid, an embodiment of the present disclosure provides a mixed-phase fluid mass flow rate measurement method applied to the throttling-type photon quantum mixed-phase flow meter 10 to achieve the above objective. The mixed-phase fluid mass flow rate measurement method provided by the present disclosure is described in detail below.

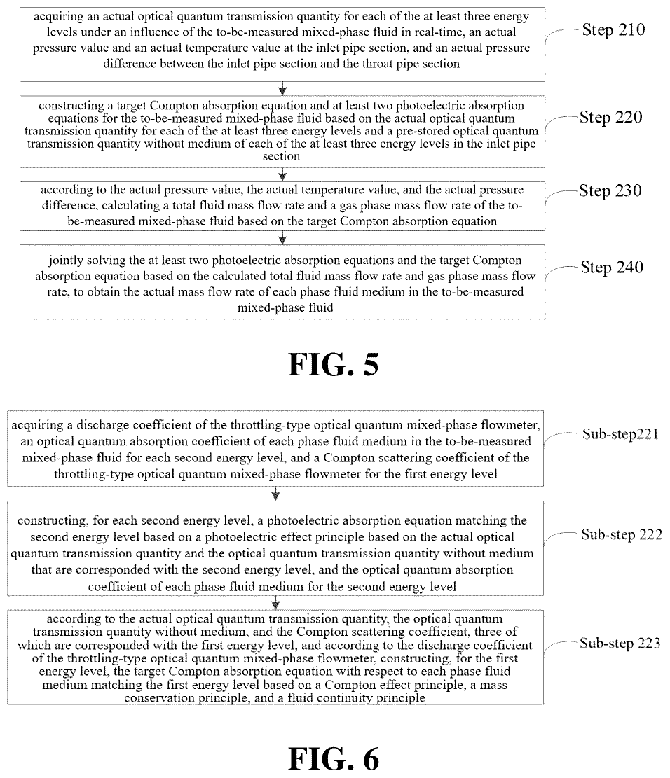

Referring to FIG. 5, FIG. 5 is one flow schematic diagram of a mixed-phase fluid mass flow rate measurement method provided in the embodiment of the present disclosure. In the embodiment of the present disclosure, the mixed-phase fluid mass flow rate measurement method can include step 210 to step 240.

Step 210: acquiring an actual photon quantum transmission quantity for each of the at least three energy levels under an influence of the to-be-measured mixed-phase fluid in real-time, an actual pressure value and an actual temperature value at the inlet pipe section, and an actual pressure difference between the inlet pipe section and the throat pipe section.

In the present embodiment, when the to-be-detected mixed-phase fluid is introduced into the hollow tube body 12, the main control unit 11 can control the multi-energy-level photon quantum source 13 to emit the at least three energy levels of photon quantum towards the to-be-detected mixed-phase fluid flowing through the inlet pipe section 121 according to a preset photon quantum emission rate, control the photon quantum probe 14 to real-time detect actual photon quantum transmission quantities of each of the at least three energy levels under the interference influence of the to-be-detected mixed-phase fluid, and simultaneously control the multi-parameter sensor 15 to real-time collect an actual pressure value and an actual temperature value of the to-be-detected mixed-phase fluid at the inlet pipe section 121 and an actual pressure difference value exhibited by the to-be-detected mixed-phase fluid between the inlet pipe section 121 and the throat pipe section 123.

Step 220: constructing a target Compton absorption equation and at least two photoelectric absorption equations for the to-be-measured mixed-phase fluid based on the actual photon quantum transmission quantity for each of the at least three energy levels and a pre-stored photon quantum transmission quantity without medium of each of the at least three energy levels in the inlet pipe section.

In the present embodiment, after the main control unit 11 real-time acquires, from the photon quantum probe 14, actual photon quantum transmission quantities respectively corresponding to the at least three energy levels, and real-time acquires, from the multi-parameter sensor 15, the actual pressure value and actual temperature value at the inlet pipe section 121, and the actual pressure difference value between the inlet pipe section 121 and the throat pipe section 123, for each second energy level among the at least three energy levels, based on the photon quantum transmission quantity without medium corresponding to the second energy level and the actual photon quantum transmission quantity, a photoelectric absorption equation corresponding to the second energy level and adapted to the to-be-detected mixed-phase fluid is constructed based on the principle of photoelectric effect principle. Meanwhile, for the first energy level among the at least three energy levels, based on the photon quantum transmission quantity without medium corresponding to the first energy level and the actual photon quantum transmission quantity, a target Compton absorption equation matched with the first energy level and adapted to the to-be-detected mixed-phase fluid is constructed based on the Compton effect principle, the mass conservation principle, and the fluid continuity principle.

Optionally, referring to FIG. 6, FIG. 6 is a flow schematic diagram of sub-steps included in step 220 in FIG. 5. In the present embodiment, the step 220 can include sub-step 221 to sub-step 223, so as to ensure that the constructed target Compton absorption equation and all photoelectric absorption equations can effectively describe the distribution condition of the actual mass flow rate of each phase fluid medium in the to-be-detected mixed-phase fluid exhibited at the inlet pipe section 121 of the hollow pipe body 12.

Sub-step 221: acquiring a discharge coefficient of the throttling-type photon quantum mixed-phase flowmeter, a photon quantum absorption coefficient of each phase fluid medium in the to-be-measured mixed-phase fluid for each second energy level respectively, and a Compton scattering coefficient of the throttling-type photon quantum mixed-phase flowmeter for the first energy level.

Sub-step 222: constructing, for each second energy level, a photoelectric absorption equation matching the second energy level based on a photoelectric effect principle based on the actual photon quantum transmission quantity and the photon quantum transmission quantity without medium that are corresponded with the second energy level, and the photon quantum absorption coefficient of each phase fluid medium for the second energy level.

For the i-th (i=1, . . . , m, where m is used to represent the total number of second energy levels involved in the multi-energy-level photon quantum source 13) type of second energy level among all second energy levels, the photoelectric absorption equation matched with the i-th type of second energy level can be expressed by the following formula:

$$ln ( \frac{{N}_{0 , i}}{{N}_{X , i}} ) = {\sum }_{j = 1}^{n} {α}_{j , i} {Q}_{j} ,$$

where N_{0,i} is used to represent the actual photon quantum transmission quantity corresponding to the i-th type of second energy level, N_{X,i} is used to represent the photon quantum transmission quantity without medium corresponding to the i-th type of second energy level, α_{j,i} is used to represent the photon quantum absorption coefficient of a j-th phase fluid medium in the to-be-measured mixed-phase fluid for the i-th type of second energy level, Qⱼ is used to represent the actual mass flow rate of the j-th phase fluid medium in the to-be-measured mixed-phase fluid, and n is used to represent a total number of fluid medium phases of the to-be-measured mixed-phase fluid.

Taking the case where the to-be-detected mixed-phase fluid includes a water-phase fluid medium, an oil-phase fluid medium, a solid-phase fluid medium, and a gas-phase fluid medium as an example, the gas-phase fluid medium can be taken as the first phase fluid medium in the to-be-detected mixed-phase fluid, the oil-phase fluid medium can be taken as the second phase fluid medium in the to-be-detected mixed-phase fluid, the water-phase fluid medium can be taken as the third phase fluid medium in the to-be-detected mixed-phase fluid, and the solid-phase fluid medium can be taken as the fourth phase fluid medium in the to-be-detected mixed-phase fluid.

Sub-step 223: according to the actual photon quantum transmission quantity, the photon quantum transmission quantity without medium, and the Compton scattering coefficient, three of which are corresponded with the first energy level, and according to the discharge coefficient of the throttling-type photon quantum mixed-phase flowmeter, constructing, for the first energy level, the target Compton absorption equation with respect to each phase fluid medium matching the first energy level based on a Compton effect principle, a mass conservation principle, and a fluid continuity principle.

For the existing mixed-phase flowmeter implemented by a conventional Venturi tube, since it actually performs photon quantum measurement on the to-be-detected mixed-phase fluid after the influence of the throttling effect at the throat pipe section, the conventional Compton absorption equation conforming to the Compton effect at the throat pipe section for the existing mixed-phase flowmeter can be expressed as follows:

$$\{ \begin{matrix}{Q}_{t} = {\sum }_{j = 1}^{n} {Q}_{j} = {C}^{′} * K * ε \sqrt{Δ P * {ρ}_{MIX}} \\ ln ( \frac{{N}_{0 , A}^{′}}{{N}_{X , A}^{′}} ) = {M}^{′} * {ρ}_{MIX}\end{matrix} ,$$

where

$${N}_{0 , A}^{′}$$

is used to represent the actual photon quantum transmission quantity of the photon quantum energy level conforming to the Compton effect for the to-be-detected mixed-phase fluid at the throat pipe section in the conventional Venturi tube,

$${N}_{X , A}^{′}$$

is used to represent the photon quantum transmission quantity without medium of the photon quantum energy level conforming to the Compton effect at the throat pipe section in the conventional Venturi tube, Qₜ is used to represent the total fluid mass flow rate of the to-be-detected mixed-phase fluid, M′ is used to represent the Compton scattering coefficient of the photon quantum energy level conforming to the Compton effect at the conventional Venturi tube, C′ is used to represent the discharge coefficient of the conventional Venturi tube, K is used to represent the throttling constant of the conventional Venturi tube, E is used to represent the expansion coefficient of the conventional Venturi tube, ΔP is used to represent the actual pressure difference between the inlet pipe and the throat pipe section of the conventional Venturi tube, and ρ_{MIX} is used to represent the average mixed density of the to-be-detected mixed-phase fluid on the pipe cross-section of the throat pipe section.

However, it is noteworthy that because the throttling-type photon quantum mixed-phase flowmeter 10 provided by the present disclosure essentially performs photon quantum measurement on the to-be-detected mixed-phase fluid before the influence of the throttling effect at the inlet pipe section 121, the present disclosure needs to consider factors, including that “the gas-phase fluid medium in the to-be-detected mixed-phase fluid respectively exhibits different gas densities before and after the influence of the throttling effect, the non-gas-phase fluid medium in the to-be-detected mixed-phase fluid exhibits consistent actual density before and after the influence of the throttling effect”, “the to-be-detected mixed-phase fluid respectively exhibits different average mixed densities before and after the influence of the throttling effect”, and “the gas-phase fluid medium and the non-gas-phase fluid medium in the to-be-detected mixed-phase fluid each have the same mass flow rate before and after the influence of the throttling effect”. Then, based on the mass conservation principle and the fluid continuity principle, the conventional Compton absorption equation is deformed to construct the target Compton absorption equation matched with the first energy level and adapted to the to-be-detected mixed-phase fluid. At this time, the target Compton absorption equation matching the first energy level can be expressed by following formula:

$$\{ \begin{matrix}{Q}_{t} = {\sum }_{j = 1}^{n} {Q}_{j} = C * {ρ}_{mix 2} * \sqrt{\frac{2 Δ P}{{ρ}_{mix 2} - {ρ}_{mix 1} * {( \frac{S 2}{S 1} )}^{2}}} \\ ln ( \frac{{N}_{0 , A}}{{N}_{X , A}} ) = M * {ρ}_{mix 1}\end{matrix} ,$$

where N_{0,A} is used to represent the actual photon quantum transmission quantity corresponding to the first energy level, N_{X,A} is used to represent a photon quantum transmission quantity without medium corresponding to the first energy level, Qₜ is used to represent a total fluid mass flow rate of the to-be-measured mixed-phase fluid, M is used to represent a Compton scattering coefficient corresponding to the first energy level, C is used to represent a discharge coefficient of the throttling-type photon quantum mixed-phase flowmeter 10, ΔP is used to represent an actual pressure difference between the inlet pipe section 121 and the throat pipe section 123, ρₘᵢₓ₁ is used to represent an average mixed density of the to-be-measured mixed-phase fluid at a pipe cross-section of the inlet pipe section 121, ρₘᵢₓ₂ is used to represent an average mixed density of the to-be-measured mixed-phase fluid at a pipe cross-section of the throat pipe section 123, S1 is used to represent a pipe cross-sectional area of the inlet pipe section, and S2 is used to represent a pipe cross-sectional area of the throat pipe section 123. The pipe cross-section of the inlet pipe section 121 is the pipe port cross-section of the inlet pipe section 121 communicating with the contraction pipe section 122, and the pipe cross-section of the throat pipe section 123 is the pipe port cross-section of the throat pipe section 123 communicating with the contraction pipe section 122.

In one embodiment of the present embodiment, when the multi-energy-level photon quantum source 13 and the photon quantum probe 14 are respectively provided on two plane walls of the waist-shaped straight pipe section 127 included in the inlet pipe section 121, the pipe cross-section of the inlet pipe section 121 is the waist-shaped hole-like pipe cross-section of the waist-shaped straight pipe section 127.

Therefore, the present disclosure can, by executing the above sub-step 221 to sub-step 223, ensure that the constructed target Compton absorption equation and all photoelectric absorption equations can effectively describe the distribution condition of the actual mass flow rate of each phase fluid medium in the to-be-detected mixed-phase fluid exhibited at the inlet pipe section 121 of the hollow pipe body 12.

Step 230: according to the actual pressure value, the actual temperature value, and the actual pressure difference, calculating a total fluid mass flow rate and a gas phase mass flow rate of the to-be-measured mixed-phase fluid based on the target Compton absorption equation.

In the present embodiment, the gas phase mass flow rate is the actual mass flow rate of the gas phase fluid medium in the to-be-detected mixed-phase fluid. After the main control unit 11 acquires in real time the actual pressure value and actual temperature value at the inlet pipe section 121, and the actual pressure difference between the inlet pipe section 121 and the throat pipe section 123 from the multi-parameter sensor 15, the actual gas density (that is, the first gas density at the inlet pipe section 121) of the gas phase fluid medium before the influence of the throttling effect can be directly solved based on the Pressure-Volume-Temperature relationship associated with gas density in thermodynamics, according to the actual pressure value and actual temperature value at the inlet pipe section 121. Afterward, based on the principle of reversible adiabatic process and the Pressure-Volume-Temperature relationship in thermodynamics, the actual gas density (that is, the second gas density at the throat pipe section 123) of the gas phase fluid medium after the influence of the throttling effect is calculated. Furthermore, according to the fixed characteristic of the density/volume of the non-gas-phase fluid medium in the to-be-detected mixed-phase fluid and the fixed characteristic of the total fluid mass flow rate of the to-be-detected mixed-phase fluid before and after the influence of the throttling effect, the total fluid mass flow rate and the gas phase mass flow rate of the to-be-detected mixed-phase fluid are directly calculated based on the target Compton absorption equation.

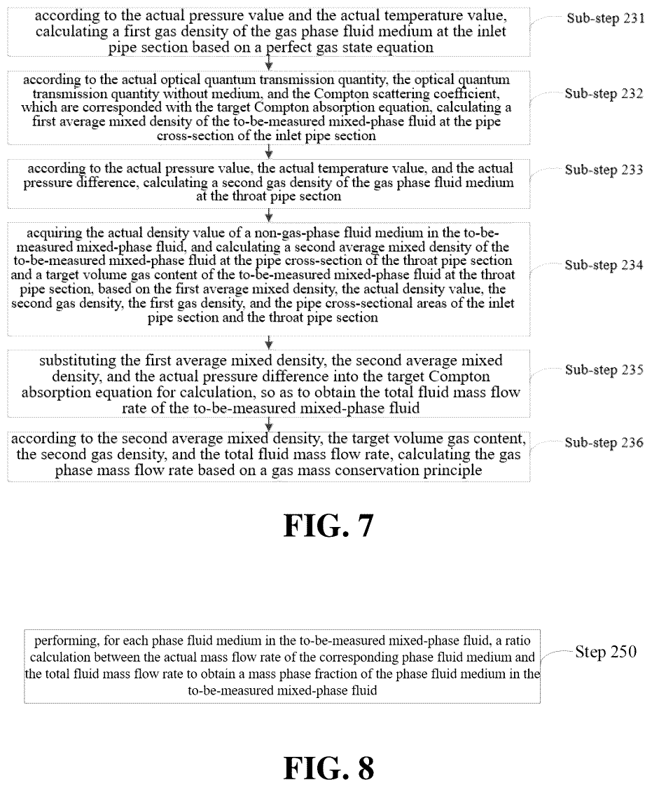

Optionally, referring to FIG. 7, FIG. 7 is a flow schematic diagram of sub-steps included in step 230 in FIG. 5. In the present embodiment, the step 230 can include sub-step 231 to sub-step 236, to accurately calculate the total fluid mass flow rate and gas phase mass flow rate of the to-be-detected mixed-phase fluid.

Sub-step 231: according to the actual pressure value and the actual temperature value, calculating a first gas density of the gas phase fluid medium at the inlet pipe section based on a perfect gas state equation.

The perfect gas state equation can be expressed as “P=ρRT, where P is used to represent the gas pressure, T is used to represent the gas temperature, R is used to represent the physical property constant of the gas, and ρ is used to represent the gas density”.

Sub-step 232: according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section.

The first average mixed density can be calculated using the formula

$$“ ln ( \frac{{N}_{0 , A}}{{N}_{X , A}} ) = M * {ρ}_{mix 1} ”$$

in the target Compton absorption equation.

Sub-step 233: according to the actual pressure value, the actual temperature value, and the actual pressure difference, calculating a second gas density of the gas phase fluid medium at the throat pipe section.

In the present embodiment, the specific step flow of the main control unit 11 executing the sub-step 233 can include sub-step a to sub-step c, specifically as follows.

Sub-step a: calculating an expected pressure value at the throat pipe section 123 based on the actual pressure value and the actual pressure difference.

The main control unit 11 can perform subtraction operation on the actual pressure value and the actual pressure difference value to obtain the expected pressure value of the gas phase fluid medium at the throat pipe section 123 (that is, the expected pressure value=actual pressure value−actual pressure difference value).

Sub-step b: calculating an expected temperature value of the gas phase fluid medium at the throat pipe section 123 based on the actual pressure value, the expected pressure value, and the actual temperature value, and based on a principle of reversible adiabatic process.

The expected temperature value can be calculated by using the formula “the expected temperature value=actual temperature value×{(expected pressure value÷actual pressure value)\hat{ }[(k−1)÷k]}, where k is used to represent the isentropic index of the gas phase fluid medium”.

Sub-step c: calculating the second gas density of the gas phase fluid medium at the throat pipe section 123 based on the expected pressure value and the actual temperature value, and based on the perfect gas state equation.

Therefore, the present disclosure can, by executing the above sub-step a to sub-step c, accurately measure the actual gas density of the gas phase fluid medium in the to-be-detected mixed-phase fluid after the influence of the throttling effect.

Sub-step 234: acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section.

In the present embodiment, the specific step flow of the main control unit 11 executing the sub-step 234 “calculating a second average mixed density of the to-be-measured mixed-phase fluid at the pipe cross-section of the throat pipe section 123 and a target volume gas content of the to-be-measured mixed-phase fluid at the throat pipe section 123, based on the first average mixed density, the actual density value, the second gas density, the first gas density, and the pipe cross-sectional areas of the inlet pipe section 121 and the throat pipe section 123” can include sub-step e to sub-step g, specifically as follows.

Sub-step e: calculating an actual volume gas content of the to-be-measured mixed-phase fluid at the inlet pipe section 121 based on the first average mixed density, the actual density value, and the first gas density.

The mathematical relationship among the first average mixed density, the actual density value, the first gas density, and the actual volume gas content can be expressed as “first average mixed density=first gas density×actual volume gas content+actual density value×(1−actual volume gas content)”.

Sub-step f: calculating the target volume gas content based on the actual volume gas content, the pipe cross-sectional areas of the inlet pipe section 121 and the throat pipe section 123, and based on a fixed property of a non-gas-phase fluid medium density.

The mathematical relationship among the actual volume gas content, the pipe cross-sectional area of the inlet pipe section 121, the pipe cross-sectional area of the throat pipe section 123, and the target volume gas content can be expressed as “target volume gas content=1−(pipe cross-sectional area of the inlet pipe section 121÷pipe cross-sectional area of the throat pipe section 123)×(1−actual volume gas content)”.

Sub-step g: performing a mixed density calculation based on the second gas density, the actual density value, and the target volume gas content to obtain the second average mixed density.

The mathematical relationship among the second average mixed density, the second gas density, the actual density value, and the target volume gas content can be expressed as “second average mixed density=second gas density×target volume gas content+actual density value×(1−target volume gas content)”.

Therefore, the present disclosure can, by executing the above sub-step f to sub-step g, accurately measure the average mixed density of the to-be-detected mixed-phase fluid after the influence of the throttling effect.

Sub-step 235: substituting the first average mixed density, the second average mixed density, and the actual pressure difference into the target Compton absorption equation for calculation, so as to obtain the total fluid mass flow rate of the to-be-measured mixed-phase fluid.

Sub-step 236: according to the second average mixed density, the target volume gas content, the second gas density, and the total fluid mass flow rate, calculating the gas phase mass flow rate based on a gas mass conservation principle.

The gas phase mass flow rate can be calculated by using the formula “Q_{g}=Qₜ*GVF₂*ρ_{g2}/ρₘᵢₓ₂”, where Q_{g} is used to represent the gas phase mass flow rate, Qₜ is used to represent the total fluid mass flow rate, ρ_{g2} is used to represent the second gas density, GVF₂ is used to represent the target volume gas content, and ρₘᵢₓ₂ is used to represent the second average mixed density.

Therefore, the present disclosure can, by executing the above sub-step 231 to sub-step 236, accurately calculate the total fluid mass flow rate and gas phase mass flow rate of the to-be-detected mixed-phase fluid.

Step 240: jointly solving the at least two photoelectric absorption equations and the target Compton absorption equation based on the calculated total fluid mass flow rate and gas phase mass flow rate, to obtain the actual mass flow rate of each phase fluid medium in the to-be-measured mixed-phase fluid.

After the main control unit 11 calculates the total fluid mass flow rate of the to-be-detected mixed-phase fluid and the actual mass flow rate (that is, the gas phase mass flow rate) of the gas phase fluid medium in the to-be-detected mixed-phase fluid, the main control unit 11 substitutes the total fluid mass flow rate and the gas phase mass flow rate respectively into the target Compton absorption equation and all the photoelectric absorption equations for joint equation solving. Thus, the actual mass flow rates of each phase fluid medium including the gas phase fluid medium in the to-be-detected mixed-phase fluid are solved, thereby ensuring the realization of high-accuracy real-time mass flow rate measurement effect for low-flow-rate mixed-phase fluid.

Therefore, the present disclosure can, by executing the above step 210 to step 240, ensure that the above throttling photon quantum mixed-phase flowmeter 10 can effectively realize high-accuracy real-time mass flow rate measurement effect for low-flow-rate mixed-phase fluid.

Optionally, referring to FIG. 8, FIG. 8 is another flow schematic diagram of a mixed-phase fluid mass flow rate measurement method provided in the embodiment of the present disclosure. In the embodiment of the present disclosure, compared with the mixed-phase fluid mass flow rate measurement method shown in FIG. 5, the mixed-phase fluid mass flow rate measurement method shown in FIG. 8 can further include step 250 to realize high-accuracy real-time mass phase fraction measurement effect for low-flow-rate mixed-phase fluid.

Step 250: performing, for each phase fluid medium in the to-be-measured mixed-phase fluid, a ratio calculation between the actual mass flow rate of the corresponding phase fluid medium and the total fluid mass flow rate to obtain a mass phase fraction of the phase fluid medium in the to-be-measured mixed-phase fluid.

Therefore, the present disclosure can, by executing the above step 250, ensure that the above throttling photon quantum mixed-phase flowmeter 10 can realize the effect of high-accuracy real-time mass phase fraction measurement for low-flow-rate mixed-phase fluid.

In summary, in the mixed-phase fluid mass flow measurement method and throttling-type photon quantum mixed-phase flowmeter provided by the present disclosure, the present disclosure can perform multi-energy-level photon quantum measurement at an inlet pipe section of the throttling-type photon quantum mixed-phase flowmeter, and can directly calculate actual mass flow rate of each phase fluid medium in the to-be-measured mixed-phase fluid based on a photoelectric effect principle, a Compton effect principle, a mass conservation principle, and a fluid continuity principle, so as to ensure applicability of the corresponding throttling-type photon quantum mixed-phase flowmeter to high-precision real-time mass flow rate measurement effect on low-flow-rate mixed-phase fluid at a low-yield oil-gas well. This effectively avoids the limitation on mass flow rate measurement capability brought to the existing mixed-phase flowmeter by the throat pipe section size. Meanwhile, the present disclosure can realize the effect of high-accuracy real-time mass phase fraction measurement for low-flow-rate mixed-phase fluid based on the throttling photon quantum mixed-phase flowmeter.

The above are only various embodiments of the present disclosure, but the scope of protection of the present disclosure is not limited thereto. Any person skilled in the art can easily envisage changes or substitutions within the technical scope disclosed in the present disclosure, which should be encompassed within the scope of protection of the present disclosure. Therefore, the scope of protection of the present disclosure should be determined by the scope of protection of the claims.

1. A mixed-phase fluid mass flow measurement method, applicable to a throttling-type photon quantum mixed-phase flowmeter, wherein the throttling-type photon quantum mixed-phase flowmeter comprises a hollow tube body, a multi-level photon quantum source, and a photon quantum probe, wherein an inlet pipe section of the hollow tube body is in communication with a throat pipe section via a contraction pipe section, and is configured to transport a to-be-measured mixed-phase fluid to the throat pipe section; the multi-level photon quantum source is arranged within the inlet pipe section and is configured to emit photon quantum of at least three energy levels according to a preset photon quantum emission rate; the photon quantum probe is arranged opposite to the multi-level photon quantum source and is configured to detect a photon quantum transmission quantity for each of the at least three energy levels; and the mixed-phase fluid mass flow measurement method comprises:
acquiring an actual photon quantum transmission quantity for each of the at least three energy levels under an influence of the to-be-measured mixed-phase fluid in real-time, an actual pressure value and an actual temperature value at the inlet pipe section, and an actual pressure difference between the inlet pipe section and the throat pipe section;
constructing a target Compton absorption equation and at least two photoelectric absorption equations for the to-be-measured mixed-phase fluid based on the actual photon quantum transmission quantity for each of the at least three energy levels and a pre-stored photon quantum transmission quantity without medium of each of the at least three energy levels in the inlet pipe section, where each absorption equation corresponds to one energy level;
according to the actual pressure value, the actual temperature value, and the actual pressure difference, calculating a total fluid mass flow rate and a gas phase mass flow rate of the to-be-measured mixed-phase fluid based on the target Compton absorption equation, wherein the gas phase mass flow rate is an actual mass flow rate of a gas phase fluid medium in the to-be-measured mixed-phase fluid; and
jointly solving the at least two photoelectric absorption equations and the target Compton absorption equation based on the calculated total fluid mass flow rate and gas phase mass flow rate, to obtain the actual mass flow rate of each phase fluid medium in the to-be-measured mixed-phase fluid.

2. The mixed-phase fluid mass flow measurement method according to claim 1, wherein a first energy level with a greatest energy value among the at least three energy levels corresponds to the target Compton absorption equation, and each second energy level among all energy levels other than the first energy level in the at least three energy levels corresponds to one photoelectric absorption equation respectively; and at this time, the step of constructing a target Compton absorption equation and at least two photoelectric absorption equations for the to-be-measured mixed-phase fluid based on the actual photon quantum transmission quantity for each of the at least three energy levels and a pre-stored photon quantum transmission quantity without medium of each of the at least three energy levels in the inlet pipe section comprises:
acquiring a discharge coefficient of the throttling-type photon quantum mixed-phase flowmeter, a photon quantum absorption coefficient of each phase fluid medium in the to-be-measured mixed-phase fluid for each second energy level respectively, and a Compton scattering coefficient of the throttling-type photon quantum mixed-phase flowmeter for the first energy level;
constructing, for each second energy level, a photoelectric absorption equation matching the second energy level based on a photoelectric effect principle based on an actual photon quantum transmission quantity and the photon quantum transmission quantity without medium that are corresponded with the second energy level, and the photon quantum absorption coefficient of each phase fluid medium for the second energy level; and
according to the actual photon quantum transmission quantity, the photon quantum transmission quantity without medium, and the Compton scattering coefficient, three of which are corresponded with the first energy level, and according to the discharge coefficient of the throttling-type photon quantum mixed-phase flowmeter, constructing, for the first energy level, the target Compton absorption equation with respect to each phase fluid medium matching the first energy level based on a Compton effect principle, a mass conservation principle, and a fluid continuity principle.

3. The mixed-phase fluid mass flow measurement method according to claim 2, wherein the photoelectric absorption equation matching a i-th type of second energy level is expressed by following formula:
$$ln ( \frac{{N}_{0 , i}}{{N}_{X , i}} ) = {\sum }_{j = 1}^{n} {α}_{j , i} {Q}_{j} ,$$
where N_{0,i} is used to represent the actual photon quantum transmission quantity corresponding to the i-th type of second energy level, N_{X,i} is used to represent the photon quantum transmission quantity without medium corresponding to the i-th type of second energy level, α_{j,i} is used to represent the photon quantum absorption coefficient of a j-th phase fluid medium in the to-be-measured mixed-phase fluid for the i-th type of second energy level, Qⱼ is used to represent the actual mass flow rate of the j-th phase fluid medium in the to-be-measured mixed-phase fluid, and n is used to represent a total number of fluid medium phases in the to-be-measured mixed-phase fluid.

4. The mixed-phase fluid mass flow measurement method according to claim 3, wherein the target Compton absorption equation matching the first energy level is expressed by following formula:
$$\{ \begin{matrix}{Q}_{t} = {\sum }_{j = 1}^{n} {Q}_{j} = C * {ρ}_{mix 2} * \sqrt{\frac{2 Δ P}{{ρ}_{mix 2} - {ρ}_{mix 1} * {( \frac{S 2}{S 1} )}^{2}}} \\ ln ( \frac{{N}_{0 , A}}{{N}_{X , A}} ) = M * {ρ}_{mix 1}\end{matrix} ,$$
where N_{0,A} is used to represent the actual photon quantum transmission quantity corresponding to the first energy level, N_{X,A} is used to represent a photon quantum transmission quantity without medium corresponding to the first energy level, Qₜ is used to represent a total fluid mass flow rate of the to-be-measured mixed-phase fluid, M is used to represent a Compton scattering coefficient corresponding to the first energy level, C is used to represent a discharge coefficient of the throttling-type photon quantum mixed-phase flowmeter, ΔP is used to represent an actual pressure difference between the inlet pipe section and the throat pipe section, ρₘᵢₓ₁ is used to represent an average mixed density of the to-be-measured mixed-phase fluid at a pipe cross-section of the inlet pipe section, ρₘᵢₓ₂ is used to represent an average mixed density of the to-be-measured mixed-phase fluid at a pipe cross-section of the throat pipe section, S1 is used to represent a pipe cross-sectional area of the inlet pipe section, and S2 is used to represent a pipe cross-sectional area of the throat pipe section.

5. The mixed-phase fluid mass flow measurement method according to claim 1, wherein the step of according to the actual pressure value, the actual temperature value, and the actual pressure difference, calculating a total fluid mass flow rate and a gas phase mass flow rate of the to-be-measured mixed-phase fluid based on the target Compton absorption equation comprises:
according to the actual pressure value and the actual temperature value, calculating a first gas density of the gas phase fluid medium at the inlet pipe section based on a perfect gas state equation;
according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section;
according to the actual pressure value, the actual temperature value, and the actual pressure difference, calculating a second gas density of the gas phase fluid medium at the throat pipe section;
acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section;
substituting the first average mixed density, the second average mixed density, and the actual pressure difference into the target Compton absorption equation for calculation, so as to obtain the total fluid mass flow rate of the to-be-measured mixed-phase fluid; and
according to the second average mixed density, the target volume gas content, the second gas density, and the total fluid mass flow rate, calculating the gas phase mass flow rate based on a gas mass conservation principle.

6. The mixed-phase fluid mass flow measurement method according to claim 5, wherein the step of according to the actual pressure value, the actual temperature value, and the actual pressure difference, calculating a second gas density of the gas phase fluid medium at the throat pipe section comprises:
calculating an expected pressure value at the throat pipe section based on the actual pressure value and the actual pressure difference;
calculating an expected temperature value of the gas phase fluid medium at the throat pipe section based on the actual pressure value, the expected pressure value, and the actual temperature value, and based on a principle of reversible adiabatic process; and
calculating the second gas density of the gas phase fluid medium at the throat pipe section based on the expected pressure value and the actual temperature value, and based on the perfect gas state equation.

7. The mixed-phase fluid mass flow measurement method according to claim 5, wherein the step of calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section comprises:
calculating an actual volume gas content of the to-be-measured mixed-phase fluid at the inlet pipe section based on the first average mixed density, the actual density value, and the first gas density;
calculating the target volume gas content based on the actual volume gas content, the pipe cross-sectional areas of the inlet pipe section and the throat pipe section, and based on a fixed property of a non-gas-phase fluid medium density; and
performing a mixed density calculation based on the second gas density, the actual density value, and the target volume gas content to obtain the second average mixed density.

8. The mixed-phase fluid mass flow measurement method according to claim 1, wherein the mixed-phase fluid mass flow measurement method further comprises:
performing, for each phase fluid medium in the to-be-measured mixed-phase fluid, a ratio calculation between the actual mass flow rate of the corresponding phase fluid medium and the total fluid mass flow rate to obtain a mass phase fraction of the phase fluid medium in the to-be-measured mixed-phase fluid.

9. A throttling-type photon quantum mixed-phase flowmeter, wherein the throttling-type photon quantum mixed-phase flowmeter comprises a hollow pipe body, a multi-level photon quantum source, a photon quantum probe, a multi-parameter sensor, and a main control unit, wherein
an inlet pipe section of the hollow pipe body is in communication with a throat pipe section via a contraction pipe section, and is configured to transport a to-be-measured mixed-phase fluid, which is injected into the inlet pipe section, to the throat pipe section;
the multi-level photon quantum source is arranged in the inlet pipe section and is configured to emit photon quantum of at least three energy levels according to a preset photon quantum emission rate;
the photon quantum probe is mounted on the hollow pipe body and is arranged opposite to the multi-level photon quantum source within the inlet pipe section, and is configured to detect the photon quantum transmission quantity of each of the at least three energy levels;
the multi-parameter sensor is mounted on the hollow pipe body and is configured to monitor in real time the actual pressure value and actual temperature value at the inlet pipe section, and the actual pressure difference between the inlet pipe section and the throat pipe section; and
the main control unit is communicatively connected with the multi-level photon quantum source, the multi-parameter sensor, and the photon quantum probe simultaneously, and is configured to control a working state of the multi-level photon quantum source, the multi-parameter sensor, and the photon quantum probe, wherein the main control unit further stores a computer program and can execute the computer program to implement the mixed-phase fluid mass flow measurement method according to claim 1.

10. The throttling-type photon quantum mixed-phase flowmeter according to claim 9, wherein the inlet pipe section comprises a large-diameter straight pipe section, a diameter-reducing pipe section, and a waist-shaped straight pipe section, wherein the large-diameter straight pipe section is in communication with the waist-shaped straight pipe section via the diameter-reducing pipe section, and the large-diameter straight pipe section is configured to inject the to-be-measured mixed-phase fluid; and
the waist-shaped straight pipe section comprises two planar walls that are parallel and arranged at intervals, the multi-level photon quantum source is arranged on one planar wall, and the photon quantum probe is arranged on the other planar wall, wherein the multi-level photon quantum source is an exempt-level Ba-133 photon quantum source.

11. The mixed-phase fluid mass flow measurement method according to claim 2, wherein the step of according to the actual pressure value, the actual temperature value, and the actual pressure difference, calculating a total fluid mass flow rate and a gas phase mass flow rate of the to-be-measured mixed-phase fluid based on the target Compton absorption equation comprises:
according to the actual pressure value and the actual temperature value, calculating a first gas density of the gas phase fluid medium at the inlet pipe section based on a perfect gas state equation;
according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section;
according to the actual pressure value, the actual temperature value, and the actual pressure difference, calculating a second gas density of the gas phase fluid medium at the throat pipe section;
acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section;
substituting the first average mixed density, the second average mixed density, and the actual pressure difference into the target Compton absorption equation for calculation, so as to obtain the total fluid mass flow rate of the to-be-measured mixed-phase fluid; and
according to the second average mixed density, the target volume gas content, the second gas density, and the total fluid mass flow rate, calculating the gas phase mass flow rate based on a gas mass conservation principle.

12. The mixed-phase fluid mass flow measurement method according to claim 3, wherein the step of according to the actual pressure value, the actual temperature value, and the actual pressure difference, calculating a total fluid mass flow rate and a gas phase mass flow rate of the to-be-measured mixed-phase fluid based on the target Compton absorption equation comprises:
according to the actual pressure value and the actual temperature value, calculating a first gas density of the gas phase fluid medium at the inlet pipe section based on a perfect gas state equation;
according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section;
according to the actual pressure value, the actual temperature value, and the actual pressure difference, calculating a second gas density of the gas phase fluid medium at the throat pipe section;
acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section;
substituting the first average mixed density, the second average mixed density, and the actual pressure difference into the target Compton absorption equation for calculation, so as to obtain the total fluid mass flow rate of the to-be-measured mixed-phase fluid; and
according to the second average mixed density, the target volume gas content, the second gas density, and the total fluid mass flow rate, calculating the gas phase mass flow rate based on a gas mass conservation principle.

13. The mixed-phase fluid mass flow measurement method according to claim 4, wherein the step of according to the actual pressure value, the actual temperature value, and the actual pressure difference, calculating a total fluid mass flow rate and a gas phase mass flow rate of the to-be-measured mixed-phase fluid based on the target Compton absorption equation comprises:
according to the actual pressure value and the actual temperature value, calculating a first gas density of the gas phase fluid medium at the inlet pipe section based on a perfect gas state equation;
according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section;
according to the actual pressure value, the actual temperature value, and the actual pressure difference, calculating a second gas density of the gas phase fluid medium at the throat pipe section;
acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section;
substituting the first average mixed density, the second average mixed density, and the actual pressure difference into the target Compton absorption equation for calculation, so as to obtain the total fluid mass flow rate of the to-be-measured mixed-phase fluid; and
according to the second average mixed density, the target volume gas content, the second gas density, and the total fluid mass flow rate, calculating the gas phase mass flow rate based on a gas mass conservation principle.

14. The mixed-phase fluid mass flow measurement method according to claim 2, wherein the mixed-phase fluid mass flow measurement method further comprises:
performing, for each phase fluid medium in the to-be-measured mixed-phase fluid, a ratio calculation between the actual mass flow rate of the corresponding phase fluid medium and the total fluid mass flow rate to obtain a mass phase fraction of the phase fluid medium in the to-be-measured mixed-phase fluid.

15. The mixed-phase fluid mass flow measurement method according to claim 3, wherein the mixed-phase fluid mass flow measurement method further comprises:
performing, for each phase fluid medium in the to-be-measured mixed-phase fluid, a ratio calculation between the actual mass flow rate of the corresponding phase fluid medium and the total fluid mass flow rate to obtain a mass phase fraction of the phase fluid medium in the to-be-measured mixed-phase fluid.

16. The mixed-phase fluid mass flow measurement method according to claim 4, wherein the mixed-phase fluid mass flow measurement method further comprises:
performing, for each phase fluid medium in the to-be-measured mixed-phase fluid, a ratio calculation between the actual mass flow rate of the corresponding phase fluid medium and the total fluid mass flow rate to obtain a mass phase fraction of the phase fluid medium in the to-be-measured mixed-phase fluid.

17. The throttling-type photon quantum mixed-phase flowmeter according to claim 9, wherein a first energy level with a greatest energy value among the at least three energy levels corresponds to the target Compton absorption equation, and each second energy level among all energy levels other than the first energy level in the at least three energy levels corresponds to one photoelectric absorption equation respectively; and at this time, the step of constructing a target Compton absorption equation and at least two photoelectric absorption equations for the to-be-measured mixed-phase fluid based on the actual photon quantum transmission quantity for each of the at least three energy levels and a pre-stored photon quantum transmission quantity without medium of each of the at least three energy levels in the inlet pipe section comprises:
acquiring a discharge coefficient of the throttling-type photon quantum mixed-phase flowmeter, a photon quantum absorption coefficient of each phase fluid medium in the to-be-measured mixed-phase fluid for each second energy level respectively, and a Compton scattering coefficient of the throttling-type photon quantum mixed-phase flowmeter for the first energy level;
constructing, for each second energy level, a photoelectric absorption equation matching the second energy level based on a photoelectric effect principle based on an actual photon quantum transmission quantity and the photon quantum transmission quantity without medium that are corresponded with the second energy level, and the photon quantum absorption coefficient of each phase fluid medium for the second energy level; and
according to the actual photon quantum transmission quantity, the photon quantum transmission quantity without medium, and the Compton scattering coefficient, three of which are corresponded with the first energy level, and according to the discharge coefficient of the throttling-type photon quantum mixed-phase flowmeter, constructing, for the first energy level, the target Compton absorption equation with respect to each phase fluid medium matching the first energy level based on a Compton effect principle, a mass conservation principle, and a fluid continuity principle.

18. The throttling-type photon quantum mixed-phase flowmeter according to claim 17, wherein the photoelectric absorption equation matching a i-th type of second energy level is expressed by following formula:
$$ln ( \frac{{N}_{0 , i}}{{N}_{X , i}} ) = {\sum }_{j = 1}^{n} {α}_{j , i} {Q}_{j} ,$$
where N_{0,i} is use to represent the actual photon quantum transmission quantity corresponding to the i-th type of second energy level, N_{X,i} is used to represent the photon quantum transmission quantity without medium corresponding to the i-th type of second energy level, α_{j,i} is used to represent the photon quantum absorption coefficient of a j-th phase fluid medium in the to-be-measured mixed-phase fluid for the i-th type of second energy level, Qⱼ is used to represent the actual mass flow rate of the j-th phase fluid medium in the to-be-measured mixed-phase fluid, and n is used to represent a total number of fluid medium phases in the to-be-measured mixed-phase fluid.

19. The throttling-type photon quantum mixed-phase flowmeter according to claim 18, wherein the target Compton absorption equation matching the first energy level is expressed by following formula:
$$\{ \begin{matrix}{Q}_{t} = {\sum }_{j = 1}^{n} {Q}_{j} = C * {ρ}_{mix 2} * \sqrt{\frac{2 Δ P}{{ρ}_{mix 2} - {ρ}_{mix 1} * {( \frac{S 2}{S 1} )}^{2}}} \\ ln ( \frac{{N}_{0 , A}}{{N}_{X , A}} ) = M * {ρ}_{mix 1}\end{matrix} ,$$
where N_{0,A} is used to represent the actual photon quantum transmission quantity corresponding to the first energy level, N_{X,A} is used to represent a photon quantum transmission quantity without medium corresponding to the first energy level, Qₜ is used to represent a total fluid mass flow rate of the to-be-measured mixed-phase fluid, M is used to represent a Compton scattering coefficient corresponding to the first energy level, C is used to represent a discharge coefficient of the throttling-type photon quantum mixed-phase flowmeter, ΔP is used to represent an actual pressure difference between the inlet pipe section and the throat pipe section, ρₘᵢₓ₁ is used to represent an average mixed density of the to-be-measured mixed-phase fluid at a pipe cross-section of the inlet pipe section, ρₘᵢₓ₂ is used to represent an average mixed density of the to-be-measured mixed-phase fluid at a pipe cross-section of the throat pipe section, S1 is used to represent a pipe cross-sectional area of the inlet pipe section, and S2 is used to represent a pipe cross-sectional area of the throat pipe section.

20. The throttling-type photon quantum mixed-phase flowmeter according to claim 9, wherein the step of according to the actual pressure value, the actual temperature value, and the actual pressure difference, calculating a total fluid mass flow rate and a gas phase mass flow rate of the to-be-measured mixed-phase fluid based on the target Compton absorption equation comprises:
according to the actual pressure value and the actual temperature value, calculating a first gas density of the gas phase fluid medium at the inlet pipe section based on a perfect gas state equation;
according to the actual photon quantum transmission quantity, the photon quantum transmission quantity without medium, and the Compton scattering coefficient, which are corresponded with the target Compton absorption equation, calculating a first average mixed density of the to-be-measured mixed-phase fluid at the pipe cross-section of the inlet pipe section;
according to the actual pressure value, the actual temperature value, and the actual pressure difference, calculating a second gas density of the gas phase fluid medium at the throat pipe section;
acquiring the actual density value of a non-gas-phase fluid medium in the to-be-measured mixed-phase fluid, and calculating a second average mixed density of the to-be-measured mixed-phase fluid at the pipe cross-section of the throat pipe section and a target volume gas content of the to-be-measured mixed-phase fluid at the throat pipe section, based on the first average mixed density, the actual density value, the second gas density, the first gas density, and the pipe cross-sectional areas of the inlet pipe section and the throat pipe section;
substituting the first average mixed density, the second average mixed density, and the actual pressure difference into the target Compton absorption equation for calculation, so as to obtain the total fluid mass flow rate of the to-be-measured mixed-phase fluid; and
according to the second average mixed density, the target volume gas content, the second gas density, and the total fluid mass flow rate, calculating the gas phase mass flow rate based on a gas mass conservation principle.
